(19) United States
(12) Patent Application Publication
(10) Pub. No.: US 2025/0001996 A1
(43) Pub. Date: Jan. 2, 2025

(54) METHOD AND APPARATUS FOR DETECTING BRAKE LINE ANOMALIES IN VEHICLES

(71) Applicant: Nuro, Inc., Mountain View, CA (US)

(72) Inventors: John William Kling, Long Beach, CA (US); Satya Chandu Ganisetty, Sunnyvale, CA (US)

(21) Appl. No.: 18/754,383

(22) Filed: Jun. 26, 2024

Related U.S. Application Data
(60) Provisional application No. 63/523,841, filed on Jun. 28, 2023.

(51) Int. Cl. B60T 17/22; B60T 13/20; B62D 65/12

(52) U.S. Cl. CPC B60T 17/221; B60T 13/20; B60T 17/222; B62D 65/12

(57) ABSTRACT

According to one aspect, a method includes applying a first force to a piston using an actuator that includes a displacement indication arrangement. The piston is part of a hydraulic braking system included in a vehicle. The hydraulic braking system includes fluid, wherein when the first force is applied to the piston, the piston moves. The method further includes determining when a pressure of the fluid reaches a target pressure, obtaining at least a first measurement of a displacement of the piston when the pressure of the fluid reaches the target pressure using the displacement indication arrangement, and determining when the at least first measurement of the displacement of the piston indicates an anomaly in the hydraulic braking system. When it is determined that the at least first measurement of the displacement of the piston indicates the anomaly, the anomaly in the hydraulic braking system is identified.

### PRIORITY CLAIM

This patent application claims the benefit of priority under 35 U.S.C. § 119 to U.S. Provisional Patent Application No. 63/523,841, filed Jun. 28, 2023, and entitled “METHOD AND APPARATUS FOR DETECTING BRAKE LINE ANOMALIES IN VEHICLES,” which is incorporated herein by reference in its entirety.

### TECHNICAL FIELD

The disclosure relates to providing systems for use with vehicles. More specifically, the disclosure relates to identifying anomalies in hydraulic braking systems of vehicles.

### BACKGROUND

The ability for vehicles, e.g., autonomous vehicles, to operate safely is critical. When a braking system of a vehicle has issues such as air bubbles in braking fluid, the braking capabilities of the braking system may be compromised. When braking capabilities are compromised, the ability for a vehicle to slow down and/or stop may be adversely affected. As a result, the vehicle may be unable to operate safely.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4 is a block diagram representation of a hydraulic braking system, e.g., hydraulic braking system 308a of FIG. 3, in accordance with an embodiment.

FIG. 5 is a block diagram representation of a brake logic arrangement, e.g., brake logic arrangement 308b of FIG. 3, in accordance with an embodiment.

FIGS. 6A and 6B are a process flow diagram which illustrates a general method of identifying a brake line anomaly in a hydraulic braking system in accordance with an embodiment.

FIG. 7 is a process flow diagram which illustrates a method of processing data obtained from a hydraulic braking system, e.g., step 629 of FIG. 6B, in accordance with an embodiment.

FIGS. 8A and 8B are a process flow diagram which illustrates a method of identifying a brake line anomaly in a hydraulic braking system that includes a test pattern in accordance with an embodiment.

### DESCRIPTION OF EXAMPLE EMBODIMENTS

### General Overview

In one embodiment, a method includes applying a first force to a piston using an actuator, the piston and the actuator being included in a hydraulic braking system, the actuator including a displacement indication arrangement, the hydraulic braking system being included in a vehicle, the hydraulic braking system including fluid, wherein when the first force is applied to the piston, the piston moves. The method further includes determining when a pressure of the fluid reaches a target pressure, obtaining at least a first measurement of a displacement of the piston when the pressure of the fluid reaches the target pressure, the at least first measurement of the displacement of the piston being obtained using the displacement indication arrangement, and determining when the at least first measurement of the displacement of the piston indicates an anomaly in the hydraulic braking system. When it is determined that the at least first measurement of the displacement of the piston indicates the anomaly, the anomaly in the hydraulic braking system is identified.

In another embodiment, an apparatus includes at least one disc, a piston assembly that includes a piston, and at least one fluid-carrying tube, the at least one fluid-carrying tube coupled to a piston assembly and to the at least one disc, the fluid-carrying tube carrying a fluid. The apparatus also includes an actuator, an actuator controller, and a pressure sensor. The actuator is configured to apply a force to the piston, and includes a displacement indication arrangement configured to measure a displacement of the piston. The actuator controller is configured to cause the actuator to apply the force on the piston, and is additionally configured to cause the actuator to release the force on the piston. The pressure sensor arranged to measure the pressure of the fluid.

According to still another aspect, a method includes assembling a hydraulic braking system in a vehicle, the hydraulic braking system includes at least one hydraulic line, at least one selected from a group including a caliper and a disc, a piston, an actuator, a pressure sensor, and a fluid. A first force is applied to the piston using the actuator, the actuator including a displacement indication arrangement, wherein when the first force causes the piston to displace. The method also includes determining, using the pressure sensor, when a fluid pressure of the fluid reaches a first pressure, and obtaining at least a first displacement measurement of the piston using the displacement indication arrangement when it is determined that the fluid pressure of the fluid is the first pressure. A determination is made as to when the at least first displacement measurement indicates an anomaly in the hydraulic braking system, and the anomaly in the hydraulic braking system is identified when the at least first displacement measurement indicates the anomaly.

A hydraulic braking system of a vehicle may be tested to determine when there are one or more anomalies, e.g., air bubbles, present in fluid in a brake line. When the braking system of the vehicle does not include a brake pedal, measurements relating to the amount of force applied to a piston of braking system, the distance of travel of the piston due to the application of the force, and a pressure of brake fluid after the application of the force may be used to determine whether there are likely to be air bubbles present in the brake fluid. When the presence of air bubbles is determined to be likely, steps may be taken to remove the air bubbles. The steps may generally include flushing fluid from a brake line or, more generally, from a hydraulic braking system.

### DESCRIPTION

Brake systems are critical components of vehicles. When a brake system of a vehicle has issues, the brake system may not function as expected and, as a result, the vehicle may be unable to operate safely. One issue associated with hydraulic brake systems is the presence of air bubbles in brake fluid. When a hydraulic brake system of a vehicle is tested to determine whether the brake system is likely to have air bubbles in brake fluid, a brake pedal of the hydraulic brake system is typically an integral part of a testing methodology.

Some autonomous vehicles may not include brake pedals, steering wheels, and/or other driver controls. When a vehicle is intended to operate autonomously, or without a driver, the vehicle may be designed and/or manufactured such that there is no brake pedal or gas pedal in the vehicle. When a braking system of a vehicle does not include a brake pedal, a determination of whether brake fluid in the braking system includes one or more air bubbles may involve the use of an actuator to apply a force to a piston of the braking system. Once the force is applied to the piston, as for example by an actuator, measurements relating to a displacement of the piston due to the application of the force and a pressure in brake fluid due to the application of the force may be taken. When the measurements indicate the presence of air bubbles in the brake fluid, steps may be taken to flush or otherwise remove the air bubbles from the brake fluid. The identification of air bubbles in fluid of a braking system of a vehicle, and the subsequent removal of the air bubbles, facilitates the safe operation of the vehicle.

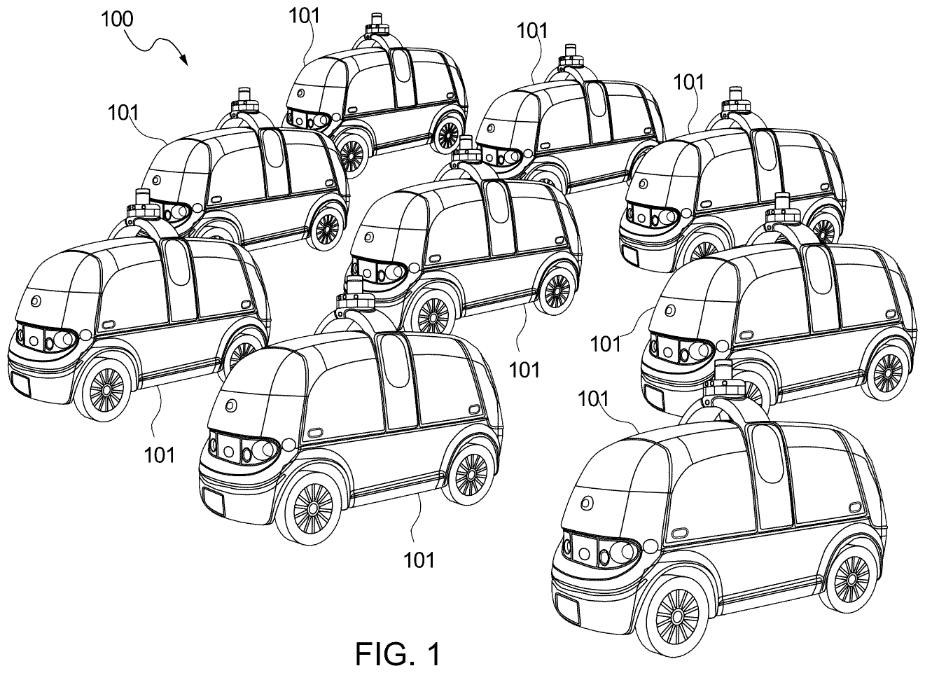

An autonomous vehicle with a hydraulic braking system may be part of a fleet of vehicles. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

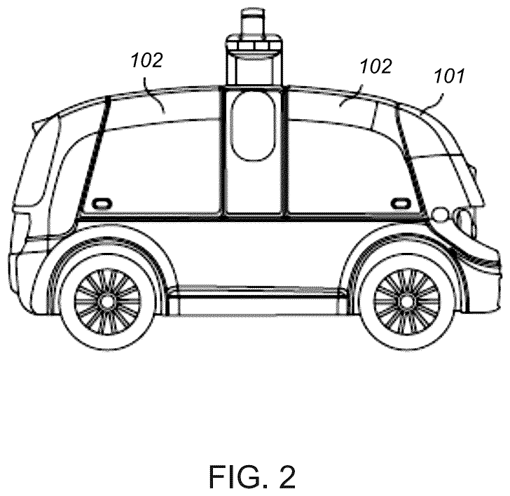

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

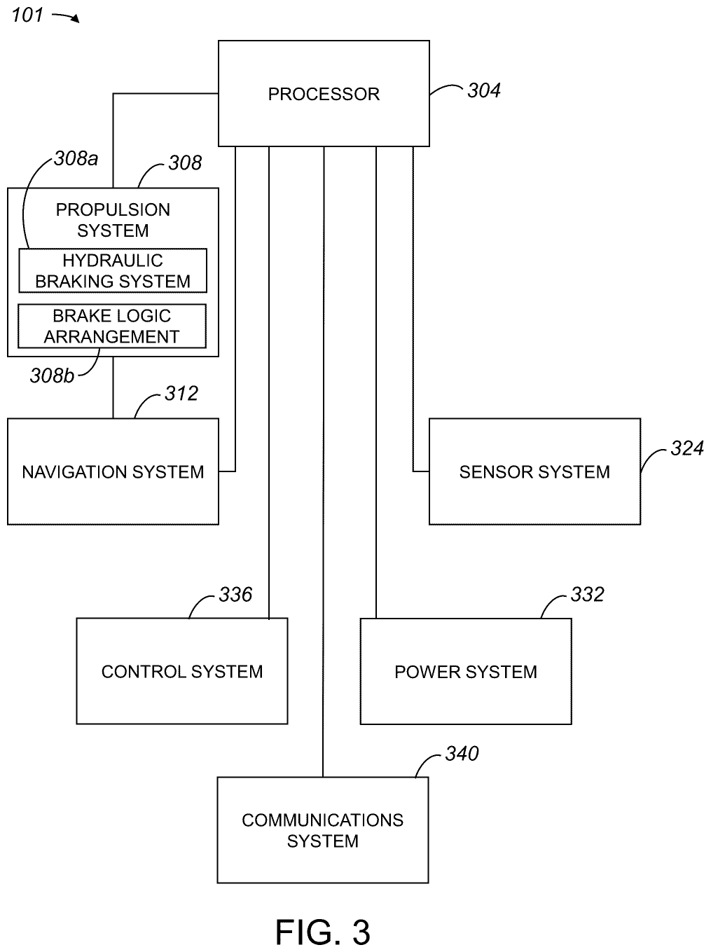

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a power system 332, a control system 336, and a communications system 340. It should be appreciated that processor 304, propulsion system 308, navigation system 312, sensor system 324, power system 332, and communications system 340 are all coupled to a chassis or body of autonomous vehicle 101.

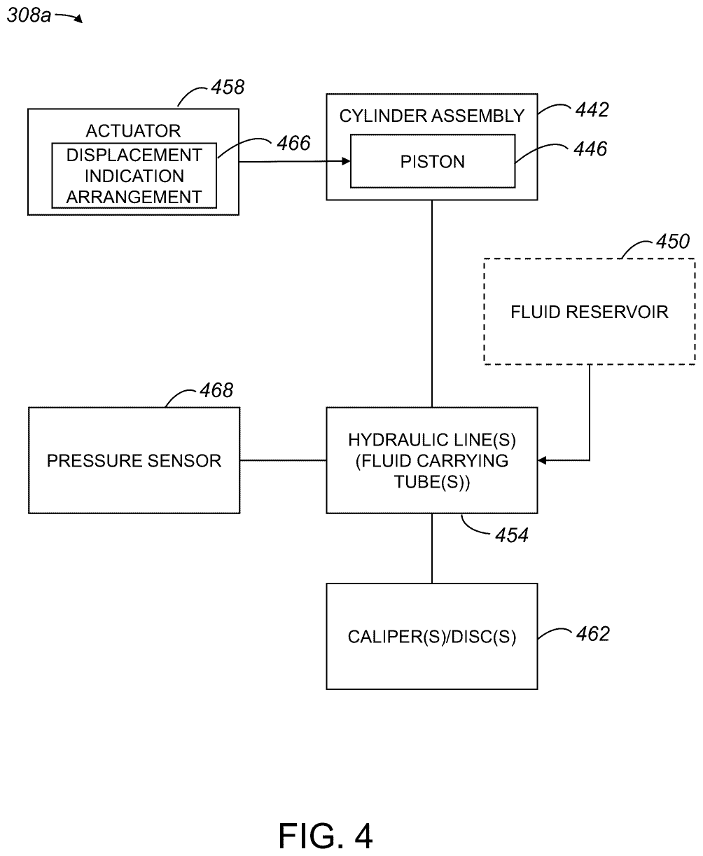

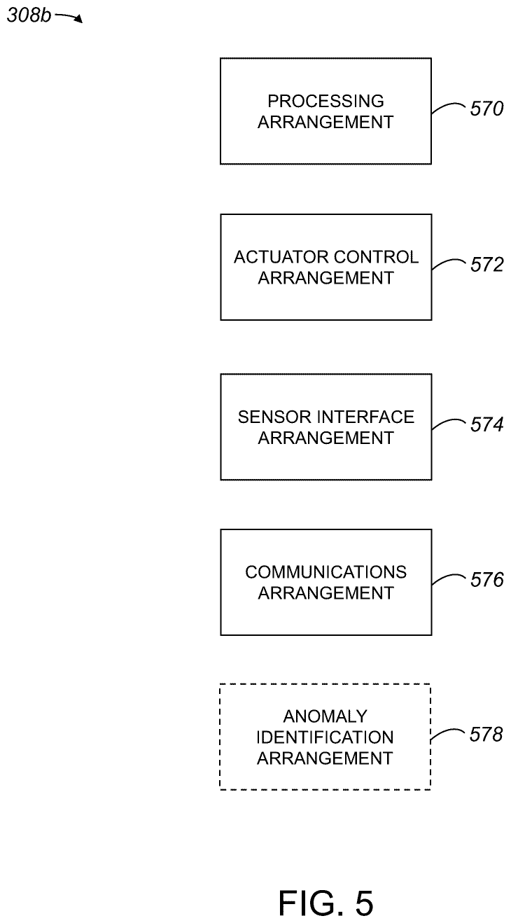

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine. In one embodiment, propulsion system 308 includes a hydraulic brake system 308a and a brake logic arrangement 308b. Brake logic arrangement 308b may be configured to control components, e.g., an actuator, within hydraulic brake system 308a and to obtain measurements from the components. Brake system 308a and brake logic arrangement 308b will be discussed in more detail below with respect to FIGS. 4 and 5, respectively.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 101.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system or module 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 101 to facilitate autonomous or semi-autonomous driving.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

A braking system, e.g., a hydraulic braking system such as hydraulic braking system 308a, may be subject to anomalies in hydraulic lines or fluid carrying tubes. The lines typically carry brake fluid, and anomalies may include, but are not limited to including, air bubbles in the brake fluid. The presence of air bubbles may compromise the ability for the braking system 308a to operate. It should be appreciated that anomalies associated with braking system 308a are not limited to including air bubbles.

In one embodiment, components within braking system 308a may effectively be leveraged to enable a determination to be made as to whether braking system 308a includes an anomaly which may compromise the ability for braking system 308a to operate as expected. For example, an actuator included in braking system 308a may apply a force to a piston in braking system 308a as part of a process to determine whether brake fluid is likely to include air bubbles.

FIG. 4 is a block diagram representation of a hydraulic braking system, e.g., hydraulic braking system 308a of FIG. 3, in accordance with an embodiment. Hydraulic braking system 308a includes a cylinder assembly 442 that has a piston 446, one or more hydraulic lines 454, an actuator 458, calipers and/or discs 462, and a pressure sensor or transducer 468. In one embodiment, braking system 308a also includes a fluid reservoir 450. It should be appreciated, however, that a fluid reservoir may instead be separate from braking system 308a.

In one embodiment, actuator 458 may be controlled, e.g., using a brake logic arrangement such as brake logic arrangement 308b of FIG. 3, such that an amount of force is applied to piston 446 to cause piston to be displaced, e.g., to translate along an axis. As piston 446 is displaced, piston changes the pressure of fluid carried in one or more hydraulic lines or fluid carrying tubes 454. The fluid is typically a brake fluid or a hydraulic fluid, and is arranged to transfer force, as for example the force applied by piston 446, into pressure applied to calipers and/or discs 462. Calipers and/or discs 462 may be arranged to substantially cause wheels of a vehicle such as vehicle 101 of FIG. 3 to stop turning and, hence, to cause the vehicle to brake. Optional fluid reservoir 450 may provide the fluid that is contained in one or more hydraulic lines 454.

The amount by which piston 446, or a piston plunger, is displaced when actuator 458 applies a force may be measured using any suitable method. By way of example, a displacement indication arrangement 466 included in actuator 458 may effectively measure the displacement of piston 446. Displacement indication arrangement 466 may include a moving portion of actuator 458 and may include a sensor that is essentially arranged to determine how much piston 448, or a piston plunger, is displaced based upon how much the moving portion moves. In one embodiment, actuator 458 may include hardware and/or software that allows actuator 458 to be controlled, as for example by brake logic arrangement 308b of FIG. 3, to apply a force to piston 446, in addition to hardware and/or software that causes displacement indication arrangement 466 to obtain measurements including, but not limited to including, a position or displacement of piston 446.

Pressure sensor 468 is configured to measure the pressure of fluid carried in one or more hydraulic lines 454. Using information obtained from displacement indication arrangement 466 and pressure sensor 468, it may be determined whether there is an issue with braking system 308a such as air bubble within the fluid carried in one or more hydraulic lines 454.

FIG. 5 is a block diagram representation of a brake logic arrangement, e.g., brake logic arrangement 308b of FIG. 3, in accordance with an embodiment. Brake logic arrangement 308a, which may include hardware and/or software logic, is generally arranged to obtain commands, e.g., from a computing system, to obtain data that may indicate whether one or more hydraulic lines 454 of FIG. 4 may have an anomaly such as air bubbles in fluid, a leak, a fluid contaminated with particulate matter, and/or a fluid with unexpected properties. The computing system may either be onboarding a vehicle such as vehicle 101 of FIG. 3, or the computing system may be separate from the vehicle but in communication with the vehicle.

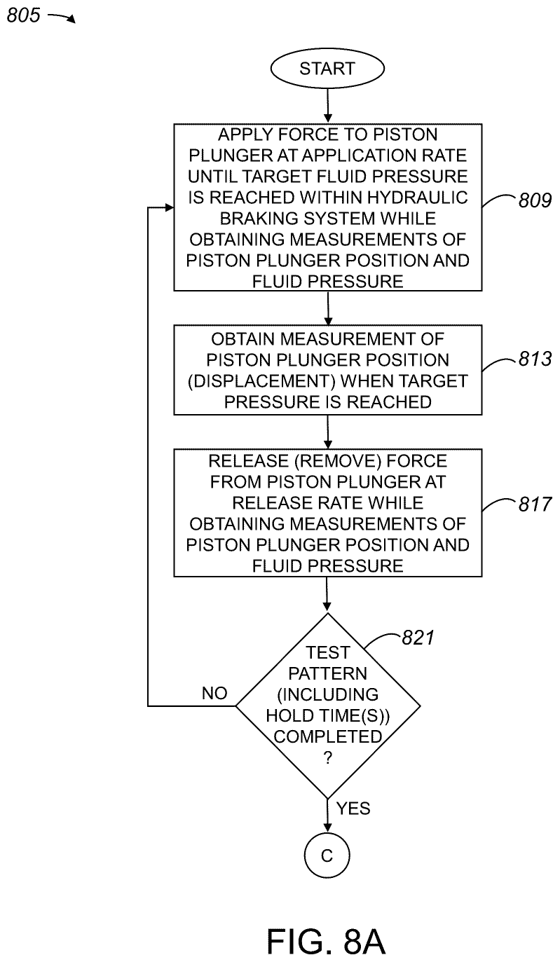

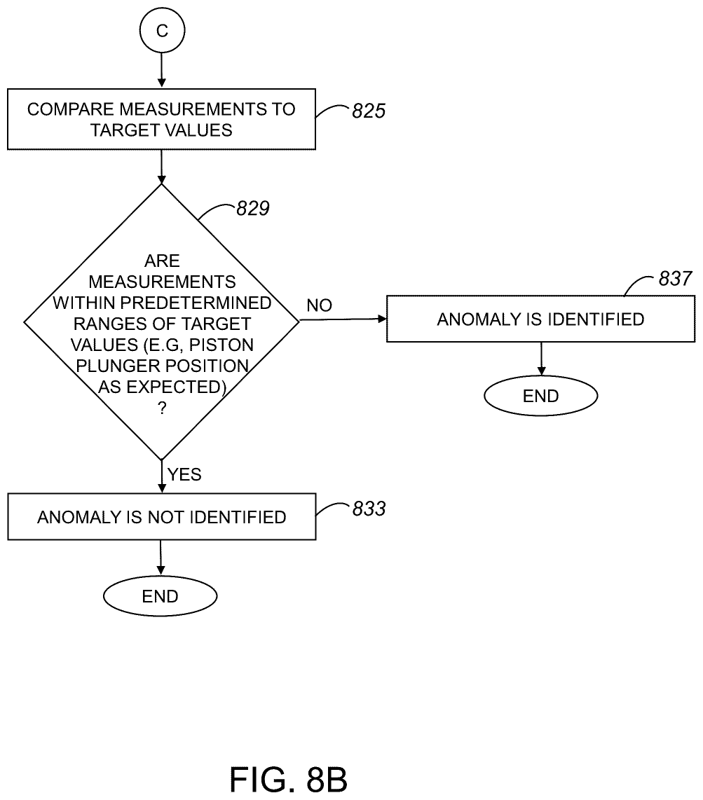

Brake logic arrangement 308b includes a processing arrangement 570, an actuator control arrangement 572, a sensor interface arrangement 574, a communications arrangement 576, and an optional anomaly identification arrangement 578. Processing arrangement 570 is generally configured to execute software logic associated with brake logic arrangement 308b. Actuator control arrangement 572 is configured to provide commands to an actuator of a braking system, e.g., actuator 458 of FIG. 4, to enable the actuator to apply a force. The commands provided by actuator control arrangement 572 may include, but are not limited to including, commands which specify an amount of force to be applied and a duration of time for which the force is to be applied. In one embodiment, actuator control arrangement 572 may provide commands which specify a test pattern that periodically, or repetitively, applies a specific amount of force for a duration of time. A test pattern will be discussed below with reference to FIGS. 8A and 8B.

Sensor interface arrangement 574 is arranged to enable information to be obtained from sensors associated with braking system 308a of FIG. 4. Communications arrangement 576 is configured to enable brake logic arrangement 308b to communicate with braking system 308a of FIG. 4, and to communicate with other systems, e.g., computing systems. Communications arrangement 576 may generally enable brake logic arrangement 308b to communicate wirelessly, and/or through wired interfaces. Optional anomaly identification arrangement 578 may be configured to obtain information relating to piston or piston plunger displacements and/or target pressures to substantially ascertain or otherwise identify when an anomaly is present. In one embodiment, optional anomaly identification arrangement 578 may configured to identify a type of anomaly. It should be appreciated that in lieu of being included in brake logic arrangement 308b, an anomaly identification arrangement may instead be included on a computer system that communicates with brake logic arrangement 308b using communications arrangement 576.

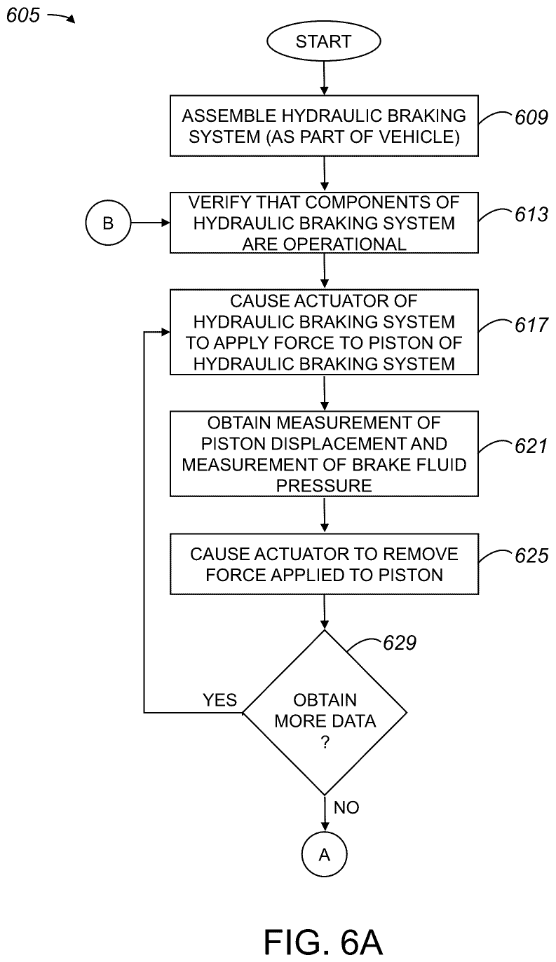

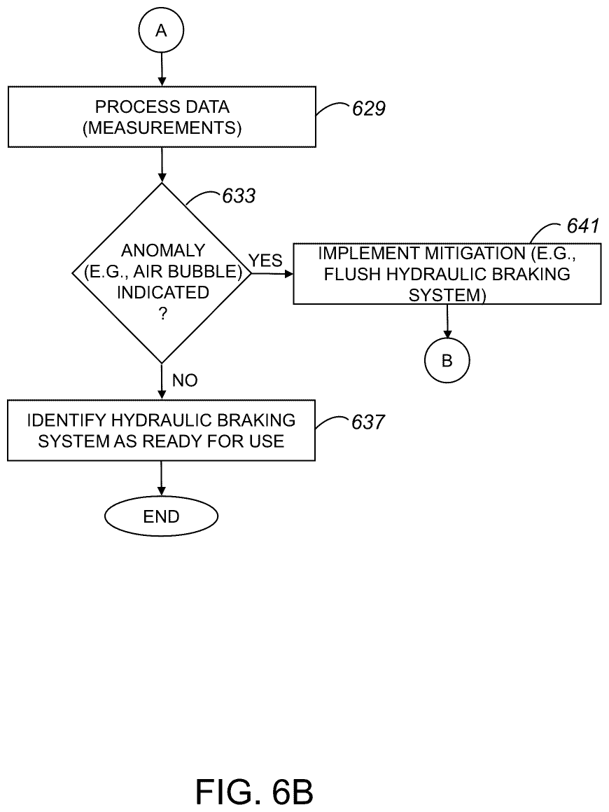

With reference to FIGS. 6A and 6B, a general method of identifying a brake line anomaly in a hydraulic braking system installed on a vehicle such as an autonomous vehicle will be described in accordance with an embodiment. A method 605 of identifying a brake line anomaly begins at a step 609 in which a hydraulic braking assembly is assembled, e.g., as part of a vehicle such as an autonomous vehicle. Assembling the hydraulic braking system may include ensuring that hydraulic or brake fluid is present in hydraulic or brake lines.

In a step 613, components of the hydraulic braking system are verified to be operational. For example, an actuator of the braking system may be tested to determine whether the actuator is functioning as expected, and a piston of the braking system may be tested to determine whether the piston is able to move in response to the application of a force.

Once components of the hydraulic braking system are verified as operational, the actuator of the hydraulic braking system is actuated, or turned on, to apply a force to a piston of the hydraulic braking system in a step 617. A brake logic arrangement may be used to apply a predetermined amount of force to the piston.

After the actuator applies a force to the piston, a measurement of piston displacement and a measurement of the pressure of brake fluid in a brake line may be obtained in a step 621. As force is applied to the piston, the piston may effectively press on the brake fluid such that the pressure of the brake fluid changes. The measurements may be obtained using any suitable method. In one embodiment, the displacement of a piston may be determined by a position associated with the actuator, e.g., a change in an actuator position as the actuator is used to apply a force to the piston. In another embodiment, the pressure of brake fluid in the brake line may be measured using a pressure sensor.

In a step 625, the actuator removes the force applied to the piston. That is, the actuator is effectively turned off and the application of force is substantially released. A determination is then made in a step 629 as to whether more data, e.g., measurements, are to be obtained. It may be determined that more data is to be collected in some instances, for example, to substantially identify average measurements.

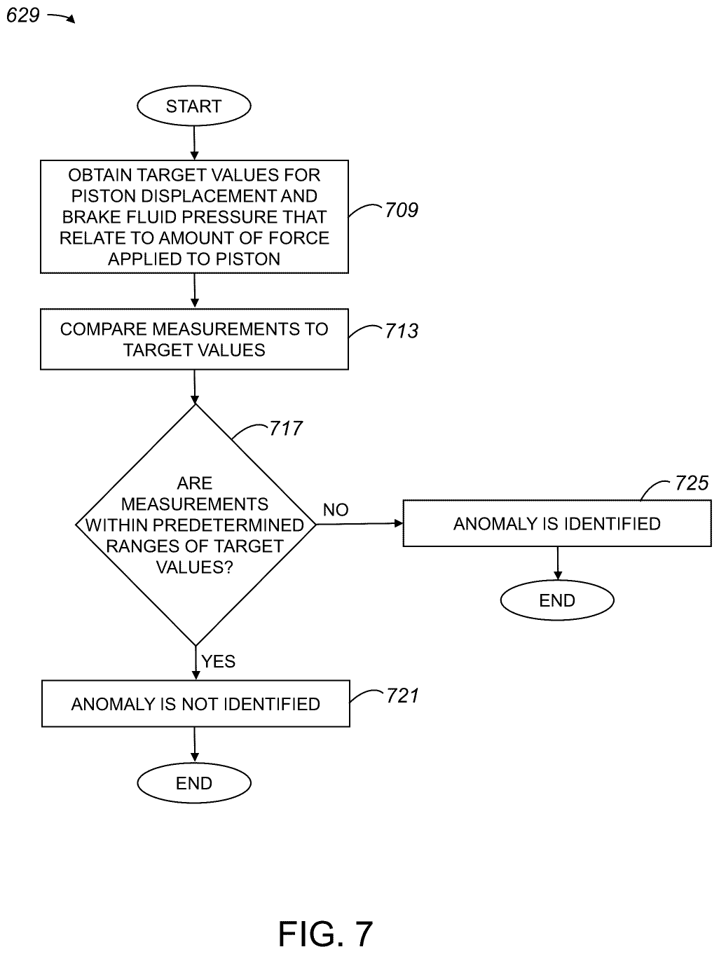

If the determination in step 629 is that more measurements are to be collected, process flow returns to step 617 in which the actuator once again applies a force to the piston. Alternatively, if it is determined in step 629 that more data is not to be obtained, process flow moves to a step 629 in which the data is processed. In general, measurements may be processed to determine whether the measurements indicate that there is a brake line anomaly such as an air bubble. One method of processing data will be discussed below with reference to FIG. 7.

Once data is processed, a determination is made in step 633 as to whether the data indicates the likely presence of an anomaly. It should be appreciated that such a determination may be made based on historical data, and whether historical data similar to the current data has been identified as being indicative of an anomaly. If it is determined that an anomaly is indicated, the mitigations may be implemented in a step 641. By way of example, if an anomaly is indicated, actions such as a flush of the hydraulic braking system may be performed to remedy the anomaly. Upon implementing a mitigation, process flow returns to step 613 on which the components of the hydraulic braking system are verified to be operations. Alternatively, if it is determined in step 633 that the data does not indicate the likely presence of an anomaly, the hydraulic braking system is identified as ready for use, and the method of identifying a brake line anomaly is completed.

Referring next to FIG. 7, a method of processing data obtained from a hydraulic braking system, e.g., step 629 of FIG. 6B, will be described in accordance with an embodiment. A method of processing data obtained from a hydraulic braking system begins at a step 709 in which target values for piston displacement and brake fluid pressure that correspond to the amount of force applied on a piston by an actuator are obtained. That is, values for piston position or displacement, and brake fluid pressure, which effectively indicate that no anomalies are present in a hydraulic braking system are obtained. Such values may be determined using historic data, and values may differ based upon the amount of force applied to a piston. In one embodiment, data is stored in data structures such as tables in a database that may be accessed by a computing system which is used to assess whether a hydraulic braking system is characterized by any anomalies.

The measurements obtained from a hydraulic braking system, e.g., in step 621 of FIG. 6A, are compared to the target values in a step 713. Then, in a step 717, it is determined whether the measurements are within predetermined ranges of the target values. A predetermined range may be arranged to specify that if a measurement is in a particular range of a target value, the measurement may effectively be considered to be consistent with the target value.

If it is determined in step 717 that the measurements are within predetermined ranges of target values, the implication is that the hydraulic braking system is substantially free of anomalies, e.g., that there are essentially no air bubbles in brake fluid. Accordingly, process flow moves from step 717 to a step 721 in which an anomaly is not identified, and the method of processing data is completed.

Alternatively, if it is determined in step 717 that one or more measurements are not within a predetermined range of target values, the indication is that there is likely to be an anomaly present in the hydraulic braking system. As such, an anomaly is identified in a step 725, and the method of processing data is completed.

In one embodiment, a method of identifying a brake line anomaly in a hydraulic braking system installed on a vehicle may involve applying a test pattern. For example, the application of a test pattern may involve substantially repetitively or periodically applying a force to a piston at a particular rate. The particular rate may be applied for a predetermined amount of time and/or until a target pressure is reached within a hydraulic braking system. A test pattern may generally be a substantially predefined pattern that may be used to obtain information which may enable a determination to be made as to whether a brake line anomaly is likely to be present.

FIGS. 8A and 8B are a process flow diagram which illustrates a method of identifying a brake line anomaly in a hydraulic braking system that includes a test pattern in accordance with an embodiment. A method 805 of identifying a brake line anomaly that utilizes a test pattern begins at a step 809 in which a force is applied to a piston plunger at a predetermined application rate until a target fluid pressure is reached or otherwise attained within the hydraulic braking system. While the force is applied to the piston plunger at the predetermined application rate, measurements of fluid pressure within the hydraulic braking system and piston plunger position or displacement may be obtained. The number of measurements obtained may vary widely, as for example based on requirements or guidelines of an enterprise that manages a fleet of vehicles that has hydraulic braking systems.

In a step 813, once a target fluid pressure is reached, a measurement of the piston plunger position or displacement is obtained. After a measurement of the piston plunger position that corresponds to the target fluid pressure is obtained, the force is released or removed from the piston plunder at a predetermined release rate in a step 817. It should be appreciated that measurements of piston plunger position and fluid pressure may be obtained while the force is released, and that the number of measurements taken may vary widely.

A determination is made in a step 821 as to whether a test pattern is completed. That is, it is determined whether more measurements are to be taken. When more measurements are taken, statistical variation measurements of piston plunger position and fluid pressure may effectively be calculated. In one embodiment, a test pattern may include hold times, or periods of time at which no force is applied. The hold times may enable a piston plunger to come to a stop or to reach a substantially steady state position.

If the determination in step 821 is that the test pattern is not completed, process flow returns to step 809 in which a force is applied to the piston plunger at a predetermined application rate. Alternatively, if the determination is that the test pattern is completed, then in a step 825, a comparison of measurements are made to target values. As previously mentioned, multiple measurements taken while implementing the test pattern may be used to obtain statistical variation measurement values that may be compared to target values.

In a step 829, it is determined whether the measurements are within predetermined ranges of target values. For example, it may be determined whether the position or displacement of the piston plunger is as expected if there are no anomalies present in a hydraulic braking system. If it is determined that the measurements are within predetermined ranges of target values, then an anomaly is not identified in a step 833, and the method of identifying a brake line anomaly that utilizes a test pattern is completed.

Alternatively, if the determination in step 829 is that the measurements are not within predetermined ranges of target values, then an anomaly is identified in a step 837, and the method of identifying a brake line anomaly that utilizes a test pattern is completed. It should be understood that when an anomaly is identified, steps may be taken to address the anomaly.

Although only a few embodiments have been described in this disclosure, it should be understood that the disclosure may be embodied in many other specific forms without departing from the spirit or the scope of the present disclosure. By way of example, while methods used to identify a brake line anomaly in a braking system of a vehicle have been described as suitable for use with vehicles which do not include a brake pedal configured to be actuated by a driver of a vehicle, such methods may also be used with respect to brake systems in vehicles that include brake pedals. In other words, in lieu of engaging a brake pedal to ascertain whether there are brake line anomalies, an actuator may be used to apply a force to a piston of a braking system that includes a brake pedal.

As mentioned above, a process of identifying whether there is an anomaly in a braking system such as an air bubble in brake fluid may involve applying force one time to a piston and taking measurements, or may involve applying force more than one time to the piston and taking measurements. It should be understood if force is applied more than one time to the piston, as for example as part of a test pattern, the amount of force applied may either be the same for each application, or the amount of force may differ. Rates of change of piston position when force is applied to a piston, and rates of change of pressure when force is applied to the piston may be measured, and comparisons may be made to determine whether the rates of change of piston position and/or rates of change of pressure are indicative of an anomaly in a braking system.

In one embodiment, once a nominal or target value for a distance travelled by a piston in response to the application of a particular amount of force to the piston and a nominal or target value for a pressure of brake line fluid are identified for the particular amount of force, it may be determined whether actual values for a displacement of the piston and a pressure of brake line fluid indicate the presence of an anomaly. For instance, an actual displacement that is greater than a target displacement, and/or an actual pressure of brake line fluid that is lower than a target pressure of brake line fluid may indicate the presence of one or more air bubbles in the brake line.

Actual displacements of a piston or piston plunger, when a force or pressure is applied, may identify a type of anomaly associated with a brake line or brake line fluid. For example, a particular amount of displacement given a particular fore or pressure applied may be correlated to a type of brake line anomaly. As previously mentioned, while brake line anomalies may generally be air bubbles, brake line anomalies are not limited to being air bubbles. Other brake line anomalies may include, but are not limited to including, leaks in brake lines and/or particulate matter in brake line fluid.

A value for pressure of brake fluid within a brake line and/or a value for a displacement of a piston plunger that may be indicative of an anomaly may vary depending upon the physical characteristics of a brake system. For instance, a value for pressure and/or a value for displacement may vary depending upon an amount of force applied to a piston plunger, a diameter of a brake line, a density of brake line fluid, etc.

The amount of force applied to a piston or piston plunger, and/or a target pressure within a hydraulic braking system achieved when applying force to a piston or piston plunger, may vary. In one embodiment, force may be applied at an application rate of approximately twenty bars per second (bar/s) released at a release rate of approximately thirty-six bar/s, and a target pressure may be approximately thirty-six bars. Generally, a target pressure may be between approximately zero bars and approximately fifty bars. An amount of displacement or a position of a piston may vary based upon the geometry of a hydraulic braking system. The variable geometry may include, but is not limited to including, a size of a piston and sizes of other components of a hydraulic braking system. The amount of force applied, the target pressure, the rate at which force is applied and released, an amount of displacement associated with a piston plunger upon the application of a force, etc. may all vary based upon the geometry of a hydraulic braking system. By way of example, the amount of displacement may be in a range of approximately zero millimeters (mm) to approximately 300 mm. When a measured amount of displacement, or an average measure amount of displacement, is not within a range of approximately ten to twenty percent of an expected value or range of values for a displacement, an anomaly may be indicated. For instance, if an expected displacement is approximately 200 mm, a measured amount of displacement that is more than approximately 20 mm off from the expected displacement may indicate an anomaly.

To substantially quantify when measurements of piston displacement rates and pressure change rates are indicative of an anomaly in a brake line, data may be collected under controlled conditions. For example, when a brake system is manufactured, measurements may be taken when the brake system is known to have no anomalies in a brake line and forces are applied to cause piston displacement. Measurements may also be taken when anomalies such as air bubbles are injected into the brake line and forces are applied to cause piston displacement. The collected measurements may then be used as indicators of which measurements are indicative of an anomaly in a brake line.

The number of cycles of force application associated that effectively define a test pattern may vary. Additionally, hold times associated with test patterns may also vary. For example, hold times, or amounts of time when a target pressure is maintained or when an approximately zero pressure is maintained between applications of force to a piston, may vary from approximately one second to approximately three seconds.

As previously mentioned, historical information may be used to determine when measurements such as piston displacements may be indicative of an anomaly such as an air bubble in a brake line. The historical information may be obtained as part of a calibration process. For instance, when certain piston displacements for particular applied forces and target pressures historically indicate the presence of an anomaly, such information may be recorded in a database and subsequently used to identify when a particular brake system is likely to have an anomaly.

Tests may be performed at any suitable time to ascertain whether anomalies are present in a brake line. A test for anomalies in a brake line may be performed as part of an end-of-line audit when a vehicle is newly manufactured, prior to the vehicle being delivered or otherwise put to use. A test for anomalies in a brake line may also be performed when a vehicle is started up or otherwise initialized for use, as well as while the vehicle is in use or in need of repair. In other words, tests for anomalies in a brake line may be performed as part of a vehicle verification process, a vehicle start-up or initialization process, and/or a vehicle diagnostic process.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner. The autonomous vehicle may be occupantless, or may be arranged to transport occupants.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples are not to be limited to the details given herein, but may be modified within the scope of the appended claims.

What is claimed is:

1. A method comprising:
applying a first force to a piston using an actuator, the piston and the actuator being included in a hydraulic braking system, the actuator including a displacement indication arrangement, the hydraulic braking system being included in a vehicle, the hydraulic braking system including fluid, wherein when the first force is applied to the piston, the piston moves;
determining when a pressure of the fluid reaches a target pressure;
obtaining at least a first measurement of a displacement of the piston when the pressure of the fluid reaches the target pressure, the at least first measurement of the displacement of the piston being obtained using the displacement indication arrangement;
determining when the at least first measurement of the displacement of the piston indicates an anomaly in the hydraulic braking system; and
when it is determined that the at least first measurement of the displacement of the piston indicates the anomaly, identifying the anomaly in the hydraulic braking system.

2. The method of claim 1 wherein determining when the at least first measurement of the displacement of the piston indicates the anomaly includes determining when the at least first measurement of the displacement of the piston is within a predetermined range of a target value; and
when it is determined that the at least first measurement of the displacement of the piston is within the predetermined range of the target value, identifying an anomaly in the hydraulic braking system.

3. The method of claim 1 further including:
flushing out the hydraulic braking system after identifying the anomaly in the hydraulic braking system, wherein flushing out the hydraulic braking system includes removing the fluid from the hydraulic braking system.

4. The method of claim 1 further including:
releasing the first force from the piston when the target pressure is reached while applying the first force;
applying a second force to a piston after releasing the first force from the piston using the actuator;
determining when a pressure of the fluid reaches the target pressure when the second force is applied to the piston; and
obtaining at least a second measurement of a displacement of the piston when the pressure of the fluid reaches the target pressure when the second force is applied to the piston, the at least second measurement of the displacement of the piston being obtained using the displacement indication arrangement.

5. The method of claim 4 further including:
processing the at least first measurement and the at least second measurement to determine an average measurement, wherein determining when the at least first measurement of the displacement of the piston indicates the anomaly includes determining when the average measurement is within a predetermined range of a target value; and
when it is determined that the average measurement is within the predetermined range of the target value, identifying the anomaly in the hydraulic braking system.

6. The method of claim 1 wherein the anomaly is an air bubble in the fluid.

7. An apparatus comprising:
at least one disc;
a piston assembly, the piston assembly including a piston;
at least one fluid-carrying tube, the at least one fluid-carrying tube coupled to a piston assembly and to the at least one disc, the fluid-carrying tube carrying a fluid;
an actuator, the actuator configured to apply a force to the piston, the actuator including a displacement indication arrangement configured to measure a displacement of the piston;
an actuator controller, the actuator controller configured to cause the actuator to apply the force on the piston, the actuator controller further being configured to cause the actuator to release the force on the piston; and
a pressure sensor, the pressure sensor arranged to measure the pressure of the fluid.

8. The apparatus of claim 7 wherein the actuator controller is configured to cause the actuator to apply the force on the piston until the pressure of the fluid reaches a target pressure, wherein the displacement indication arrangement is configured to obtain a first measurement of the displacement of the piston when the pressure of the fluid is at the target pressure.

9. The apparatus of claim 8 further including:
an anomaly identification arrangement, the anomaly identification arrangement configured to determine when the first measurement indicates a presence of an anomaly in the at least one fluid-carrying tube.

10. The apparatus of claim 9 wherein the anomaly identification arrangement is configured to determine when the first measurement indicates the presence of the anomaly by determining when the first measurement is not within a predetermined range of at least one target value.

11. The apparatus of claim 7 wherein the apparatus is a vehicle.

12. The apparatus of claim 11 wherein the vehicle is an autonomous vehicle.

13. A method comprising:
assembling a hydraulic braking system in a vehicle, the hydraulic braking system includes at least one hydraulic line, at least one selected from a group including a caliper and a disc, a piston, an actuator, a pressure sensor, and a fluid;
applying a first force to the piston using the actuator, the actuator including a displacement indication arrangement, wherein when the first force causes the piston to displace;
determining, using the pressure sensor, when a fluid pressure of the fluid reaches a first pressure;
obtaining at least a first displacement measurement of the piston using the displacement indication arrangement when it is determined that the fluid pressure of the fluid is the first pressure;
determining when the at least first displacement measurement indicates an anomaly in the hydraulic braking system; and
identifying the anomaly in the hydraulic braking system when the at least first displacement measurement indicates the anomaly.

14. The method of claim 13 further including:
verifying that the hydraulic braking system is operational before applying the first force to the piston.

15. The method of claim 13 further including:
determining when to obtain at least a second displacement measurement of the piston before determining when the at least first displacement measurement indicates the anomaly.

16. The method of claim 15 wherein when it is determined that the at least second displacement measurement of the piston is to be obtained, the method further includes:
applying a second force to the piston using the actuator, wherein when the second force causes the piston to displace;
determining, using the pressure sensor, when a fluid pressure of the fluid reaches the first pressure after applying the second force to the piston; and
obtaining at least a second displacement measurement of the piston using the displacement indication arrangement when it is determined that the fluid pressure of the fluid is the first pressure after applying the second force to the piston.

17. The method of claim 16 further including:
determining an average displacement measurement using the at least first displacement measurement and the at least second displacement measurement, wherein
determining when the at least first displacement measurement indicates the anomaly includes determining when the average displacement measurement indicates the anomaly, and wherein identifying the anomaly when the at least first displacement measurement indicates the anomaly includes identifying the anomaly when the average displacement measurement indicates the anomaly.

18. The method of claim 13 further including removing the first force using the actuator after obtaining the at least first displacement measurement of the piston.

19. The method of claim 13 wherein the anomaly is an air bubble in the fluid.

20. The method of claim 19 further including:
flushing the fluid from the hydraulic braking system after identifying the anomaly.
